(19) United States
(12) Patent Application Publication
(10) Pub. No.: US 2008/0064017 A1
(43) Pub. Date: Mar. 13, 2008

(54) SUTURE TRAINING DEVICE

(76) Inventors: Ramond Grundmeyer III, Wichita, KS (US); Lucas Kanady, Wichita, KS (US); Ronald Degon, Wichita, KS (US); Ruben West, Topeka, KS (US)

Correspondence Address: SHUGHART THOMSON & KILROY, PC, 120 WEST 12TH STREET, KANSAS CITY, MO, 64105, US

(21) Appl. No.: 11/846,224

(22) Filed: Aug. 28, 2007

Related U.S. Application Data
(60) Provisional application No. 60/840,827, filed on Aug. 29, 2006.

(51) Int. Cl. G09B 23/28

(52) U.S. Cl. 434/262

(57) ABSTRACT

A training device is provided to assist medical, dental and veterinary students in the surgical procedure of suturing wounds having a multiple structures that permit the practicing of tying sutures in a variety of situations and conditions and having an artificial tissue that can be tensioned or compressed into various states of resistance against the drawing closed of a wound with sutures.

### CROSS REFERENCE TO RELATED APPLICATION

This application claims priority under 35 U.S.C. 119(e) and 37 C.F.R. 1.78(a)(4) based upon copending U.S. Provisional Application Ser. No. 60/840,827 for Suture Training Device filed Aug. 29, 2006 and which is incorporated herein by reference.

### FIELD OF THE INVENTION

The present invention relates to the field of medical training devices. More particularly, the field of the invention is devices to assist medical, dental and veterinary personnel in the surgical procedure of suturing wounds by providing a device that permits the practicing of tying sutures in a variety of situations and conditions.

### BACKGROUND OF THE INVENTION

Suturing is a method of closing wounds. It is a technique that is thousands of years old. It is, in its most simple form, the sewing or stitching together of the edges of the wound to close the open space between the edges of the wound. Suturing serves to strengthen the wound site during the process of healing and helps avoid re-injury to the partially healed wound by avoiding tearing of the wound and reopening of the wound. Further, suturing joins joining of the skin edges to reduce scarring and to minimize the potential infection to an open wound.

The objects in teaching suturing are to teach proper suturing technique which comprises not only proper execution of the suture itself but also proper suture type selection and proper placement of the sutures along the area of the wound. During the course of suture training, it is necessary that a student become conversant in the application of cutaneous sutures, subcutaneous sutures, mattress sutures, buried sutures, as well as a variety of other sutures varieties and techniques. Historically, the use of pig's feet or other readily available and inexpensive animal bi-products have been used as suture training devices. The limitations of such a structure for lacking variety, not to mention the drawback of peutrification, makes the use of animal fragments undesirable. While a number of synthetic structures which mimic various portions of the human body have been available for many years, and these structures tend to be limited in their lifetime of use in that the device is formed as a portion of an arm or a leg, and the repeated use of the device tends to weaken and destroy the material which the device is composed thus rendering it ineffective for teaching after a period of use.

### SUMMARY OF THE INVENTION

The device described herein permits the student to practice tying sutures in a variety conditions and circumstances and permits the student to create variations in the tensioning of an artificial skin and tissue area of the device to better simulate wounds at various locations of the body. The device further is provided with structures that allow the simulation of suturing on tubular structures such as blood vessels and tendons and suturing in obstructed areas or in deep wounds in which a suture must be applied to an area that is several centimeters below the skin surface incision.

It is one object of the device to provide the student with an artificial tissue that can be tensioned or compressed into various states of resistance to simulate variations in drawing closed a wound with sutures to allow the student to better experience different tissue types and different tissue conditions with which the student may be confronted during the actual application of sutures.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTIONS OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a front and right side perspective view of the suture training kit;

FIG. 2 is an exploded view of the suture training kit;

FIG. 3 is a top plan view of the suture training kit;

FIG. 4 is a cross section view taken along line 4-4 of FIG. 3;

FIG. 5 shows the creation of an incision in the artificial tissue of the device;

FIG. 6 shows the completed incision in the artificial tissue;

FIG. 7 shows a series of sutures applied to the wound of FIG. 6 to close the wound;

FIG. 8 shows the application of a tubular member to a plurality of posts extending upwardly from the top surface of the device to simulate an artery or a vein or other tubular structures, the posts used for tensioning being selectable to provide variations in the tension of the tubular member;

FIG. 9 shows a suture applied to the tubular structures of FIG. 8;

FIG. 10 shows an alternate arrangement of the tubular structure on the posts to provide the student with a different orientation and different tension of the tubular structure which may be used to simulate tying of sutures under various tensions;

FIG. 11 shows yet another orientation of the tubular member across two posts to provide yet another orientation and different tension of the tubular structure;

FIG. 12 is a cross-section view taken along line 12-12 of FIG. 11 and showing the initial application of a suture to a rod structure which is positioned within a well thereby requiring the student to tie a suture below the surface of the test device; and

FIG. 13 shows the suture being tied within the well of FIG. 12.

### DESCRIPTION OF THE PREFERRED EMBODIMENT

As required, detailed embodiments are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

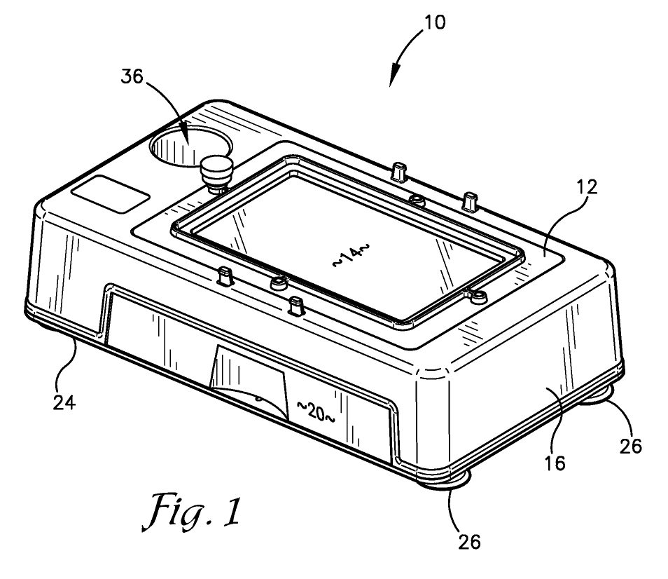

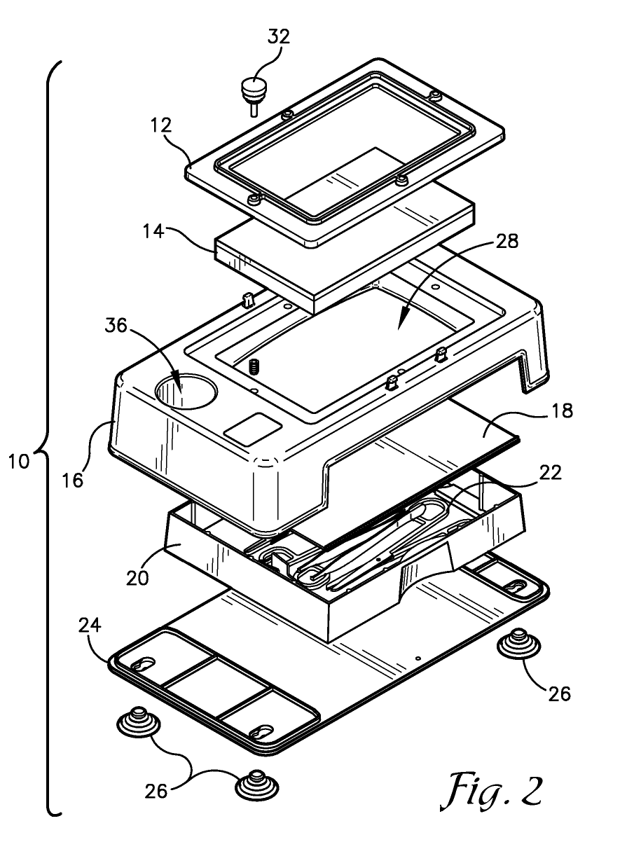

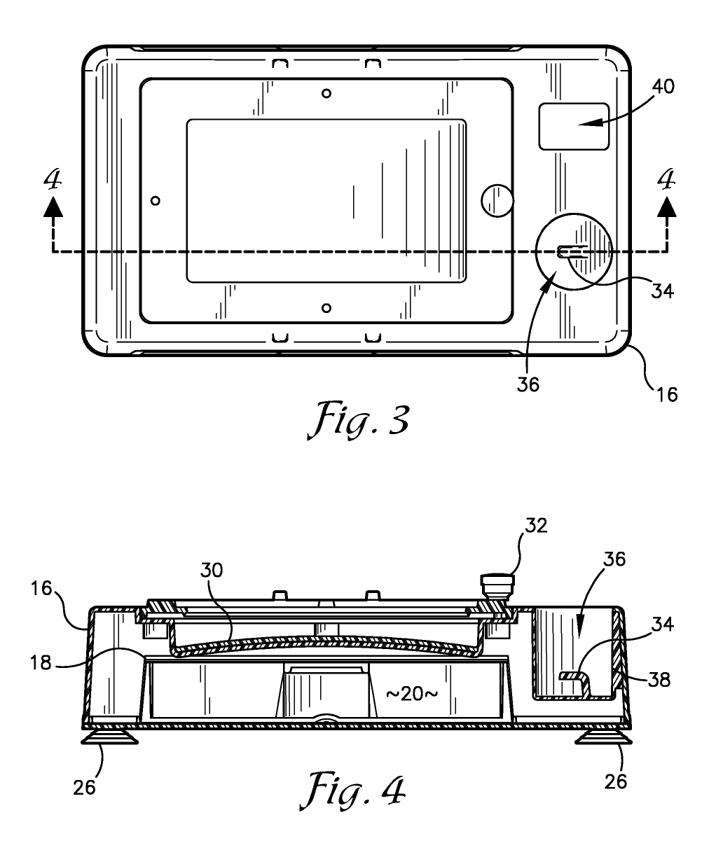

Referring now to FIG. 1, suture training device 10 is shown in perspective view. The suture training device 10 is comprised of an area of artificial tissue 14 which is mounted on training device 10 in a manner which will be described in greater detail hereinafter. Training device 10 also includes a compression ring 12 which provides a means for compression of artificial tissue 14 into frame 16 and secures artificial tissue 14 to frame 16. Referring to FIG. 2, frame 16 is provided with frame bottom plate 18 (FIG. 2) which serves to support artificial tissue 14 and separate the area of training device containing artificial tissue 14 from storage tray 20 which is insertable within frame 16 and may be withdrawn therefrom. Storage tray 20 is supported within frame 16 by base plate 24 to which suction feet 26 are attached to secure training device 10 to a table top or other surface. Referring to FIG. 3, suture training device 10 also includes supply holder or supply cup 40 which is adjacent well 36 and which may be used to hold suture material or hold various suturing instruments for the convenience of the student.

Again referring to FIG. 2, the components and the relationship of the components comprising training device 10 will be further described. Frame 16 of training device 10 is provided with a void 28 into which artificial tissue 14 may be inserted. As shown in FIG. 4, a convex support 30 may be placed into void 28 prior to the insertion of artificial tissue 14 (FIG. 2) to provide a convex projection of the surface of artificial tissue 14. The tensioning of artificial tissue 14 (FIG. 2) and the convex projection of the tissue 14 may be increased or decreased by the use of compression ring 12 and adjusting screws 32 to press artificial tissue 14 downwardly against convex support 30. The benefits of such adjustability of artificial tissue 14 will be described hereinafter. Convex support 30 (FIG. 4) is positioned just above frame bottom plate 18 which presents a close fitting top surface that is adjacent storage tray 20 thereby preventing any equipment placed in storage tray 20 from inadvertently being pressed upwardly against frame 16 thereby preventing storage tray 20 from subsequently being opened. Below storage tray 20 is base plate 24 and to which suction feet 26 are attached which allow training device 10 to be secured to a surface in substantially immobile manner.

Referring now to FIG. 3, suture training device 10 is shown in a plan view wherein the suture arm 34 at the bottom of well 36 is shown. It will be appreciated that arm 34 could extend from the sidewall of well 36 instead of projecting from the bottom surface of well 36. As may be seen in FIG. 4, and as will be described hereinafter, suture arm 34 is below the upper edge of sidewalls 38 of well 36 thereby requiring that the student use the suturing instruments to reach down into well 36 to practice tying sutures at a depth below surface level on suture arm 34. Referring to FIG. 4, the placement of suture arm 34 within well 36 may be better observed.

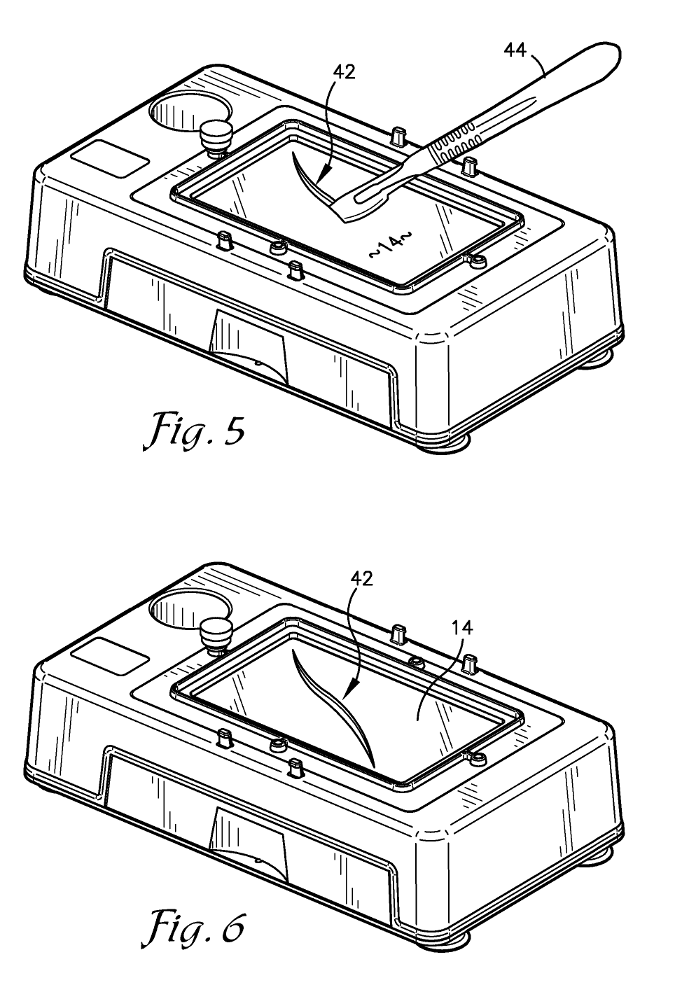

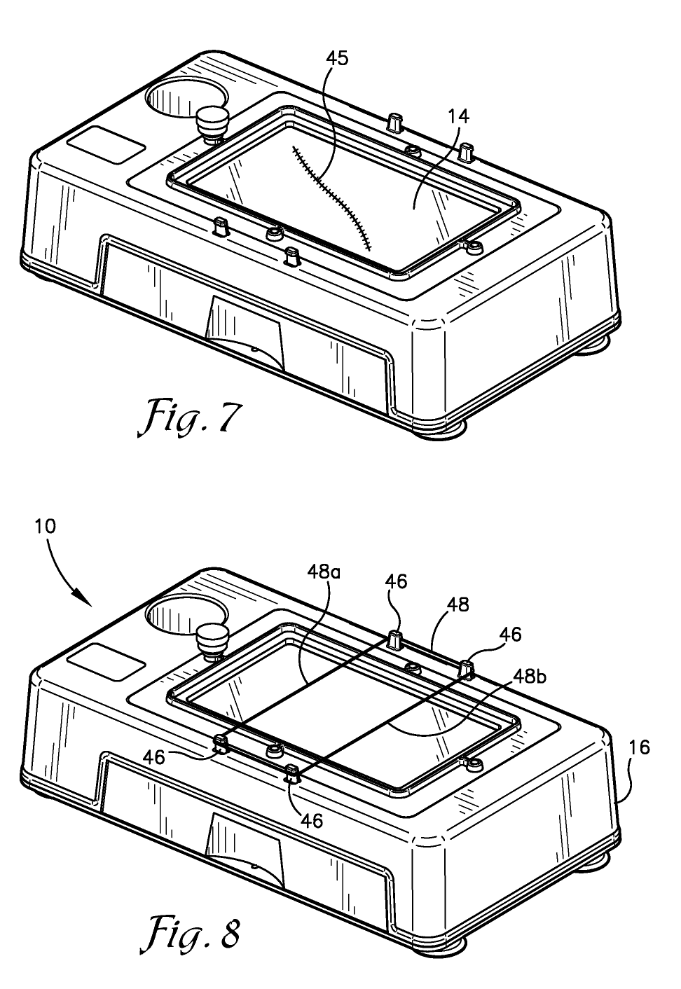

Referring now to FIG. 5, artificial tissue 14 is shown receiving an incision 42 from a scalpel 44 or other sharp device. It will be appreciated that as surgery is not the intent of the present training device, that a convenient razor blade or common knife might be used to create incision 42 as well as scalpel 44. In the described embodiment, artificial tissue 14 is provided without any preexisting cuts or incisions into the surface thereof. While it is frequently the case in prior art devices to provide a precut artificial tissue to be sutured by the student, the present device allows the student to create wounds of various shapes and sizes according to the student's desire to practice suturing under different types of conditions. The student's ability to create wounds of varying sizes and shapes will be better appreciated hereinafter upon the description of the variable compression which may be created and applied to artificial tissue 14 by the use of compression ring 12. Once an incision 42 or wound 42 has been created in artificial tissue 14, as is shown in FIG. 6, the student may proceed to apply sutures 45 to the wound as is shown in FIG. 7. It will be appreciated by those skilled in the art that the ability of the student to create wounds of various sizes, shapes and depths in the device, as well as varying the tension of artificial tissue 14 by the use of compression ring 12, will allow the student to select or create different types of wounds 14, which therefore may require different types of suturing techniques for proper closure. For instance, if a particularly deep wound is created by the student, the student may choose to insert a series of sutures deep into the wound for initial closure of the wound followed by a series of sutures near the surface of the wound for secondary closure of the wound. Alternatively, with a deep wound, the student may choose to use multiple vertical mattress sutures to close the deep wound.

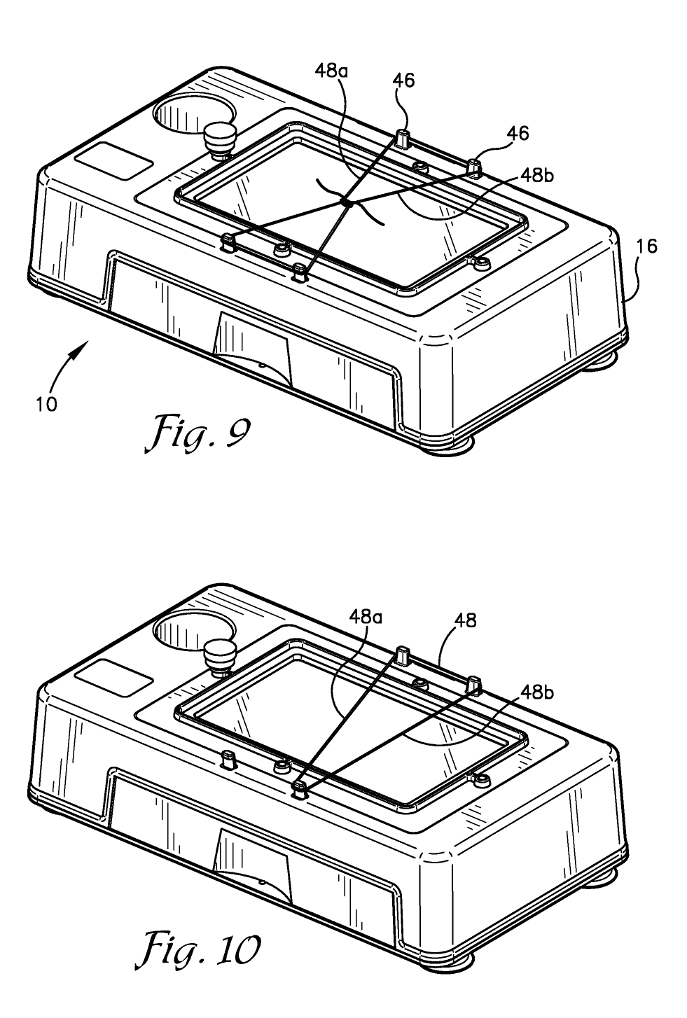

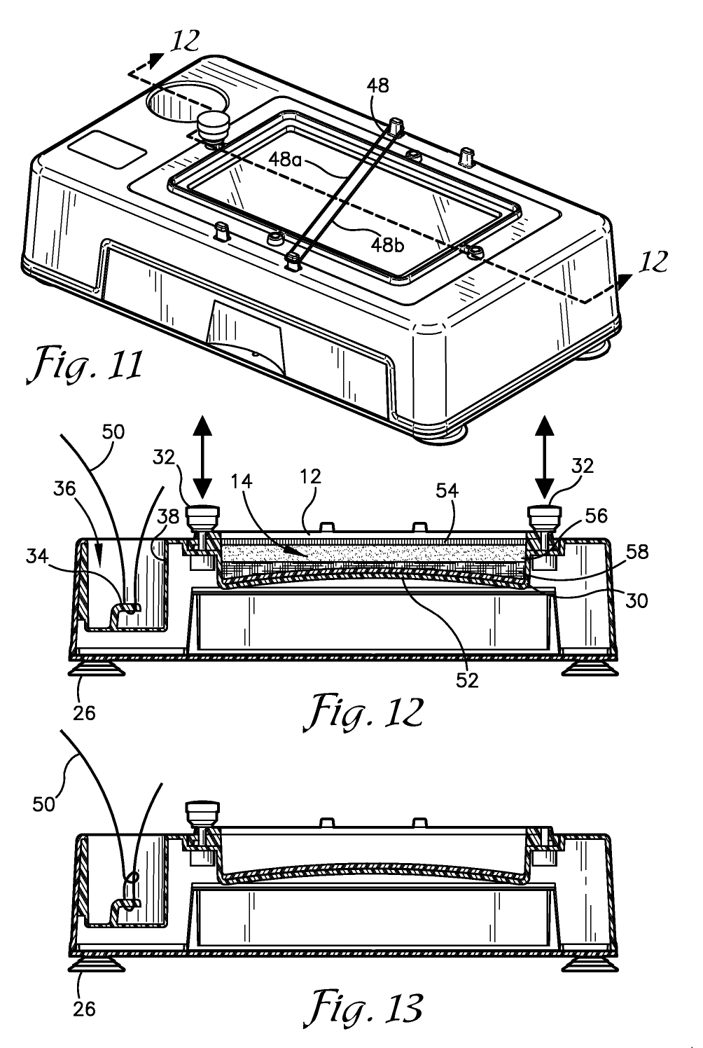

Referring now to FIG. 8, an alternate method of practicing suturing is provided by the suture training device 10 and which comprises the use of plurality of pegs 46 which extend upwardly from frame 16 of device 10. Pegs 46 are used to hold an elastic band 48. It will be appreciated by examination of FIGS. 10 and 11 that elastic band 48 may be placed in a variety of positions on two or more pegs 46 to achieve various orientations of band 48 and various degrees of resistance to compression of the two sides of band 48 created by placement of band 48 over two or more pegs 46. Continuing to refer to FIG. 8, band 48 has been placed around four pegs 46 to provide sides 48a, 48b of band 48. Once applied to pegs 46, band 48 is in position to allow a student to practice various suture techniques. It will be appreciated by those skilled in the art that the configuration of band 48 as shown in FIG. 8 allows a student to practice applying a suture to a first side of a wound 48a and a second side of a wound 48b, and to practice drawing of the two sides together, either by hand or using instruments, and to practice the tying of various suture knots in suture material without the necessity of actually using a suture needle to pass the suture material through a wound that has been created in suture material 14. Band 48 essentially provides a spaced, tensioned first and second sides which act in the manner of an opened wound and which allow the student to quickly and conveniently attempt suture practice and the drawing of the sides of a wound together and tying suture knots without the need of using the suture needle. One common instance of use of band 48 in this manner is with beginning students who wish to first practice various one handed and/or two handed sutures without troubling with the use of the suture needle. The student may also practice one handed and two handed knots and use of instruments for double throw and single throw knots. It will be appreciated that once a suture is tied, as is shown in FIG. 9 that the student may cut the suture with scissors and restore the original tension on band 48. It will also be appreciated that the student can approach band 48a and 48b as individual veins or arteries or tendons for practice of suture techniques on those tissues.

Referring now to FIGS. 10 and 11, alternate configurations of band 48 on pegs 46 are shown and which provide the student with different degrees of tensioning between sides 48a and 48b of band 48.

Referring now to FIGS. 4, 12 and 13, the use of well 36 and suture arm 34 within well 36 to practice tying of sutures which are deep within the body cavity or wound and/or which are obstructed may be practiced. As previously described in FIG. 4, it will be appreciated that well 36 is a cylinder extending some two to three inches down into frame 16. At the bottom of well 36, is positioned a suture arm 34 which is a post having a right angle bend therein and about which a suture may be tied by the student. It will be appreciated that in many instances the need to suture within a deep wound or body cavity may require the student to use instruments within an obstructed field. Well 36 with suture arm disposed therein provides a narrow and deep practice operating field for the student to attempt such suturing techniques. As is shown in FIGS. 12 and 13, suture material 50 is applied to suture arm 34, typically by the use of forceps and/or a needle holder and needle, whereupon the student may practice the tying off of the knot as is shown in FIG. 13 while using the instruments to snuggly secure the knot around suture arm 34 within well 36.

Still referring now to FIGS. 2 and 4 and 12, the benefits and operation of compression ring 12 with artificial tissue 14 will be more fully described. As previously described in reference to FIG. 2, artificial tissue 14 is disposed within void 28 of frame 16 and rests upon convex support 30 (FIG. 4), which serves to provide a central apex 52 of convex support 30 which provides a centralized upward convexity to artificial tissue 14. Referring to FIGS. 2 and 4, as artificial tissue 14 is inserted into void 28, it contacts the curvature of convex support 30 and is then pressed against the curvature of convex support 30 by the application of compression ring 12 which is secured into place on frame 16 by adjusting screws 32 (FIG. 12) of which only one of the four adjusting screws is shown in FIG. 2. In FIG. 12, two of the four adjusting screws are shown. The adjusting screws are used to increase and decrease the amount of pressure that compression ring 12 places against artificial tissue 14 and forcing it against convex support 30. Through the tightening and loosening of adjusting screws 32, variations in the taughtness of artificial tissue 14 can be achieved. These variations in the internal tensioning or taughtness of the various layers of artificial tissue 14 are achieved by increasing or decreasing the pressure of artificial tissue 14 against convex support 30 by increasing or decreasing the force of compression ring 12 against artificial tissue 13 through the tightening or loosening of adjusting screws 32. This variation in the taughtness of artificial tissue 14 provides variations in the operation of artificial tissue 14 as a student attempts to suture a wound or cut that has been placed into artificial tissue 14. It will be appreciated that with greater downward pressure by compression ring 12 that a greater taughtness or surface tension is achieved on artificial tissue 14, and that additional force must be applied by the student in tying sutures to bring together the various sides of a cut or wound 42 (FIG. 5) which is placed in artificial tissue 14. Such variations in the taughtness of artificial tissue 14 can assist the student in becoming used to suturing different areas of the body and different types of flesh conditions which might be present as, for example, when an infection has caused substantial swelling in an area of the body. Referring again to FIG. 12, the various layers which make up artificial tissue 14 are shown in cross section view. Anatomically, these layers are the epidermis 54 and camper's fascia 56 and scarpa's fascia 58.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive suture training device is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

I claim:

1. A device for training personnel in the suturing of wounds or incisions, the device comprising:
a base having a frame extending therefrom said frame comprising four sidewalls and an upper surface,
a void in said upper surface,
an artificial tissue portion disposed within said void, and
a means for compression of said artificial tissue into said void, said means for compression exposing at least a portion of said artificial tissue portion for use in training in the suturing of wounds or incisions.

2. The device as claimed in claim 1 further comprising a second void in said upper surface, said second void extending downwardly into said frame and having disposed therein an arm extending into said void at a position below said frame upper surface.

3. The device as claimed in claim 1 wherein said artificial tissue comprises a plurality of layers of rubber or foam rubber adhered together.

4. The device as claimed in claim 1 further comprising a third void in said upper surface, said third void extending downwardly into said frame and having a continuous sidewall and a bottom surface, said third void being sized to allow storage of suture materials and instruments.

5. The device as claimed in claim 1 further comprising a convex surface on a bottom surface of said first void.

6. The device as claimed in claim 1 further comprising a storage drawer in said frame for the placement of suturing materials and instruments therein.

7. The device as claimed in claim 1 wherein said means for compression comprises a ring for application to an upper surface of said artificial tissue said ring exposing at least a portion of said artificial tissue portion and at least one adjusting screw for securing said ring against said frame and said artificial tissue for compression of said ring against said tissue to provide variable surface tension in said tissue.

8. A device for training personnel in the suturing of wounds or incisions, the device comprising:
a base having a frame extending therefrom said frame comprising four sidewalls and an upper surface,
a first void in said upper surface
an artificial tissue portion disposed within said first void,
a second void in said upper surface, said second void extending downwardly into said frame and having disposed therein an arm extending into said void at a position below said frame upper surface, and
a ring for application to an upper surface of said artificial tissue said ring exposing at least a portion of said artificial tissue portion and at least one adjusting screw for securing said ring against said frame and said artificial tissue for compression of said ring against said tissue to provide variable surface tension in said tissue.

9. The device as claimed in claim 8 wherein said artificial tissue comprises a plurality of layers of rubber or foam rubber adhered together.

10. The device as claimed in claim 8 further comprising a third void in said upper surface, said third void extending downwardly into said frame and having a continuous sidewall and a bottom surface, said third void being sized to allow storage of suture materials and instruments.

11. The device as claimed in claim 8 further comprising a convex surface on a bottom surface of said first void.

12. The device as claimed in claim 8 further comprising a storage drawer in said frame for the placement of suturing materials and instruments therein.

13. A device for training personnel in the suturing of wounds or incisions, the device comprising:
a base having a frame extending therefrom said frame comprising four sidewalls and an upper surface,
a first void in said upper surface
an artificial tissue portion disposed within said first void said artificial tissue comprising a plurality of layers of rubber or foam rubber adhered together,
a convex surface on a bottom surface of said first void,
a second void in said upper surface, said second void extending downwardly into said frame and having disposed therein an arm extending into said void at a position below said frame upper surface, and
a ring for application to an upper surface of said artificial tissue said ring exposing at least a portion of said artificial tissue portion and at least one adjusting screw for securing said ring against said frame and said artificial tissue for compression of said ring against said tissue to provide variable surface tension in said tissue.

14. The device as claimed in claim 13 further comprising a third void in said upper surface, said third void extending downwardly into said frame and having a continuous sidewall and a bottom surface, said third void being sized to allow storage of suture materials and instruments.

15. The device as claimed in claim 13 further comprising a storage drawer in said frame for the placement of suturing materials and instruments therein.
